(19) United States
(12) Patent Application Publication
(10) Pub. No.: US 2013/0020793 A1
(43) Pub. Date: Jan. 24, 2013

(54) BIOMETRIC BIRTH CERTIFICATE

(71) Applicant: Larry Fuson, LaPorte City, IA (US)

(72) Inventor: Larry Fuson, LaPorte City, IA (US)

(21) Appl. No.: 13/556,138

(22) Filed: Jul. 23, 2012

Related U.S. Application Data
(63) Continuation-in-part of application No. 13/166,965, filed on Jun. 23, 2011, now abandoned.
(60) Provisional application No. 61/357,537, filed on Jun. 23, 2010.

(51) Int. Cl. B42D 15/00

(52) U.S. Cl. 283/75

(57) ABSTRACT

A biometric birth certificate has a memory device portion mounted on the certificate to store data including DNA sample results. A biometric storage area is also provided to permanently store biological materials such as hair, blood, skin, etc. A USB connector is provided to interface with a computer to upload the data. In one embodiment, an RFID chip is used. The biometric birth certificate is used to keep track of babies to prevent hospital mix-ups or in child stealing cases. A DNA sample portion holds one or more containers or sealable portion that allows the user to place a biological sample of both parents and the infant as well as umbilical cord sample. Other biometrics such as fingerprints, hair samples, nail clippings, etc. may also be stored on the DNA certificate. In one embodiment, a DNA sequencing chip is mounted on the certificate to provide instant analysis.

### CROSS REFERENCE TO RELATED APPLICATIONS

This is a continuation in part of U.S. patent application Ser. No. 13/166,965, filed Jun. 23, 2011, which in turn claims priority to Provisional Application No. 61/357,537, filed on Jun. 23, 2010, the complete disclosures of each of which are hereby incorporated by reference.

### BACKGROUND OF THE INVENTION

Keeping track of a person's identity is becoming more important in today's society. However, even in historical times, being able to prove parentage was sometimes an issue as evidenced by the famous story of king Solomon judging between two woman both claiming to be the mother. The wise king was able to discern the truth, but short of being the wisest human, science has provided us with many tools to determine identity.

Even with many safeguards and protocols in place, it is not unknown to have a hospital mix up babies and parents are sent home with the wrong children. Science has provided us with tools such as blood types to try to determine those that could not be the parents; it has only recently become possible to show with great certainty parentage. DNA testing is becoming more common and is often employed forensically in criminal cases.

There is a need for a positive identification instrument that relies on the science of DNA to prove identity that is inexpensive, easy to use and promotes long term viability of the DNA sample and allows a user to store the information digitally.

### SUMMARY OF THE INVENTION

A biometric birth certificate has a memory device portion mounted on the certificate to store data including DNA sample results. A biometric storage area is also provided to permanently store biological materials such as hair, blood, skin, etc. A USB connector is provided to interface with a computer to upload the data. In one embodiment, an RFID chip is used. The biometric birth certificate is used to keep track of babies to prevent hospital mix-ups or in child stealing cases. A DNA sample portion holds one or more containers or sealable portion that allows the user to place a biological sample of both parents and the infant as well as umbilical cord sample. Other biometrics such as fingerprints, hair samples, nail clippings, etc. may also be stored on the DNA certificate. In one embodiment, a DNA sequencing chip is mounted on the certificate to provide instant analysis.

Other features and advantages of the instant invention will become apparent from the following description of the invention which refers to the accompanying drawings.

### BRIEF DESCRIPTION OF THE DRAWINGS

FIG. 1 is an illustration of a DNA enabled birth certificate according to an embodiment of the invention.

FIG. 2 is an illustration of the DNA enabled birth certificate shown in FIG. 1 with an alternative DNA enabled storage system and biometric.

FIG. 3 is an illustration of the DNA enabled birth certificate shown in FIG. 1 with another alternative DNA storage system.

FIG. 4 is an illustration of a DNA enabled identity certificate according to an embodiment of the invention.

FIG. 5 is an illustration of a DNA enabled identification card according to an embodiment of the invention.

FIG. 6 is an illustration of a DNA enabled identification card attached to a chain according to an embodiment of the invention.

FIG. 7 is an illustration of a biometric birth certificate with a DNA sequencing chip mounted therein.

FIG. 8A is an illustration of the biometric birth certificate with a USB interface and computer storage in an enabled position.

FIG. 8B is an illustration of the biometric birth certificate with a USB interface and computer storage in a storage position.

FIG. 9 is an illustration of the biometric birth certificate with a computer DNA printout section.

FIG. 10 is an illustration of a biometric birth certificate with a RFID chip.

FIG. 11 is an illustration of a biometric birth certificate according to an embodiment of the invention.

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

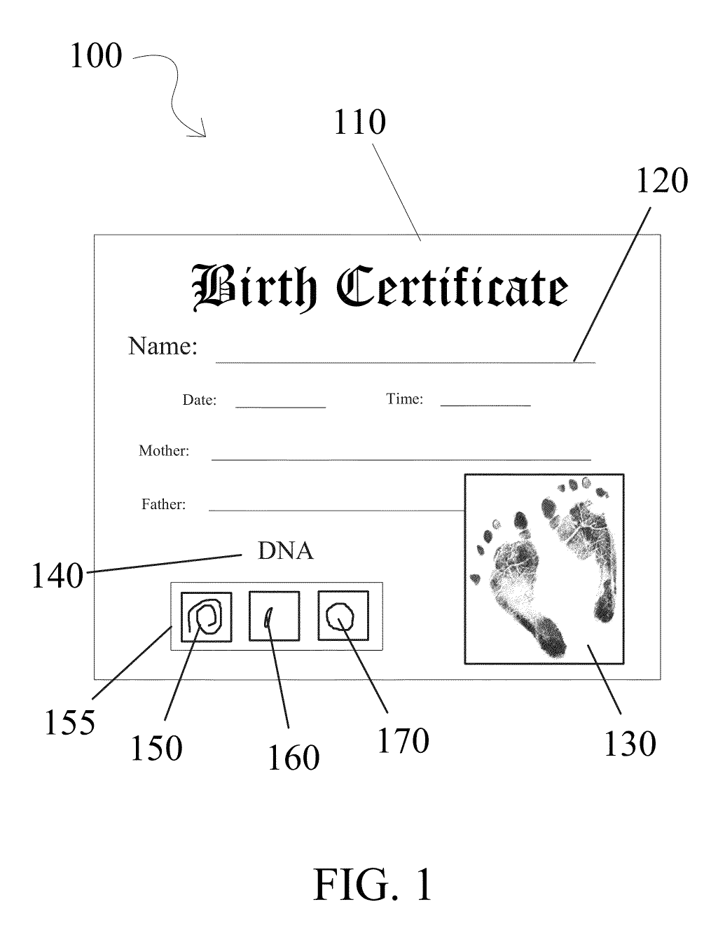

Referring to FIG. 1, a DNA birth certificate 100 is shown having a certificate 110 with printed information 120 such as name, date and time of birth along with parental information. Of course other information may be included or excluded since the information shown is merely representative of common kinds of information found on birth certificates. In addition to written information 120, graphical information such as footprints 130 may be applied.

A DNA sample area 140 is provided to allow a user to secure DNA containing samples to DNA birth certificate 100. Many kinds of biologically active samples may be used such as hair 150, nail clipping 160 and blood 170. These samples are sealed within a laminated section 155 to preserve the samples. Of course any biologically active sample may be used as long as it is practical to fit within the area provided 155 and contains intact DNA.

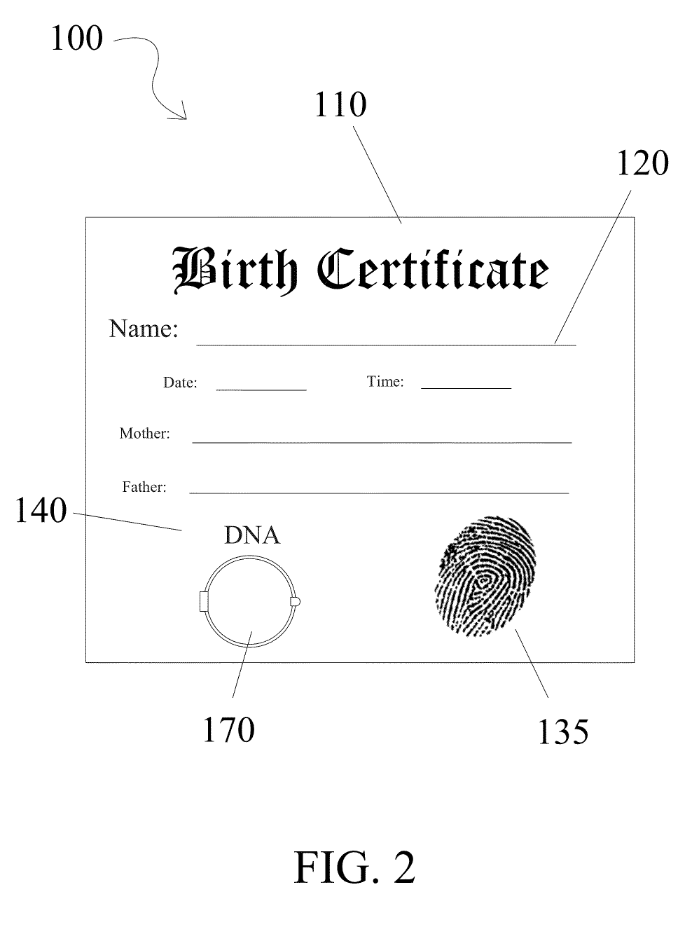

Now referring to FIG. 2, DNA birth certificate 100 is shown having a fingerprint 135 and a DNA sample container 170. DNA sample container 170 is attached to DNA birth certificate 100 and opens to allow the user to place a DNA containing biological sample within and then seal shut. Container 170 may be round as shown or any other suitable shape. Container 170 is relatively thin so that is does not stick out very far from the surface of DNA birth certificate 100, but again, other shapes could be used. Again, as discussed above, although fingerprint 135 is shown, other biometric identifiers could be used.

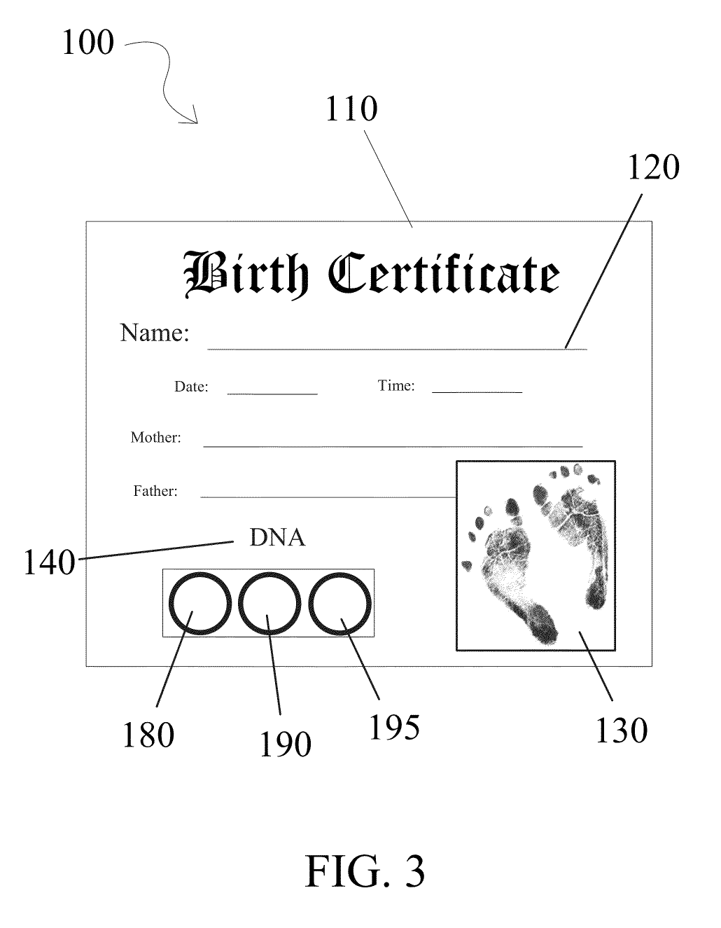

Referring now to FIG. 3, DNA birth certificate 100 is shown having a special DNA receiving section 140 with three DNA storage areas 180, 190 and 195 respectively. The material shown is known as WHATMAN© FTA© Classic Card© and is the subject of several patents. It allows for dry storage of DNA samples for years at room temperature without degrading. Of course other kinds of DNA storage materials may used as long as they preserve the DNA without significant degradation.

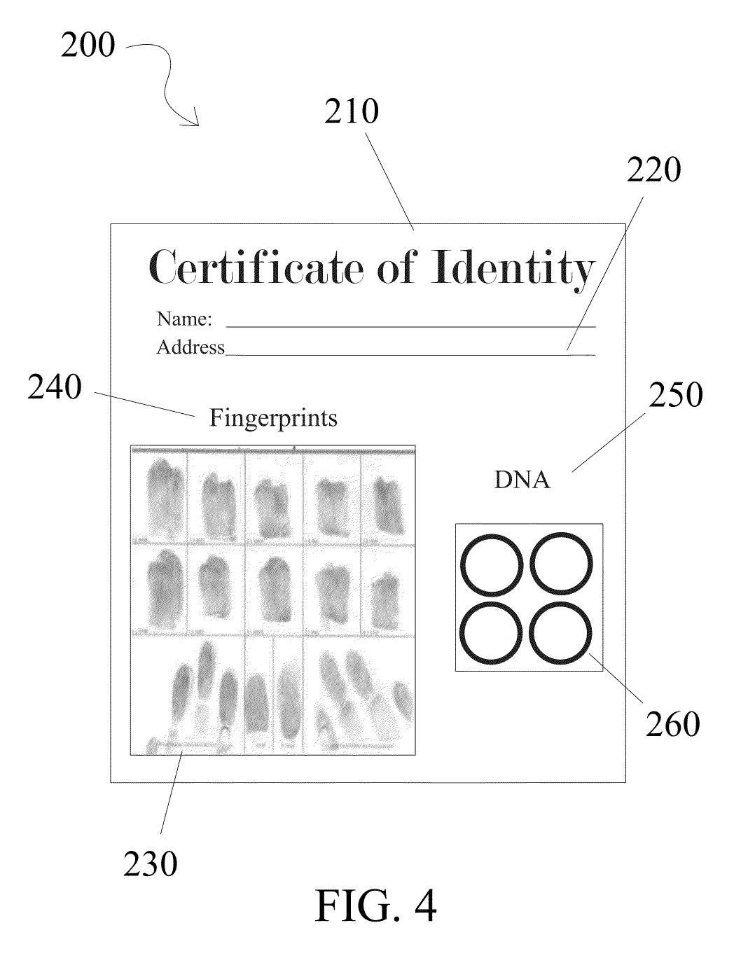

Referring now to FIG. 4, a DNA certificate of identity 200 is shown having a certificate 210 with written identification information 220 thereon. Although only name and address is shown, other kinds of identifying information may be provided such as age, weight, height, eye color, etc. to further help identify a person.

A biometric sample area 240 is shown having fingerprints 230. Again, other biometrics may be used such as physical samples, etc. In addition to fingerprints 230, a DNA sample area 250 is provided to store DNA samples on a FTA© CLASSIC CARD© 260. Again, other DNA preserving devices may be used as discussed above.

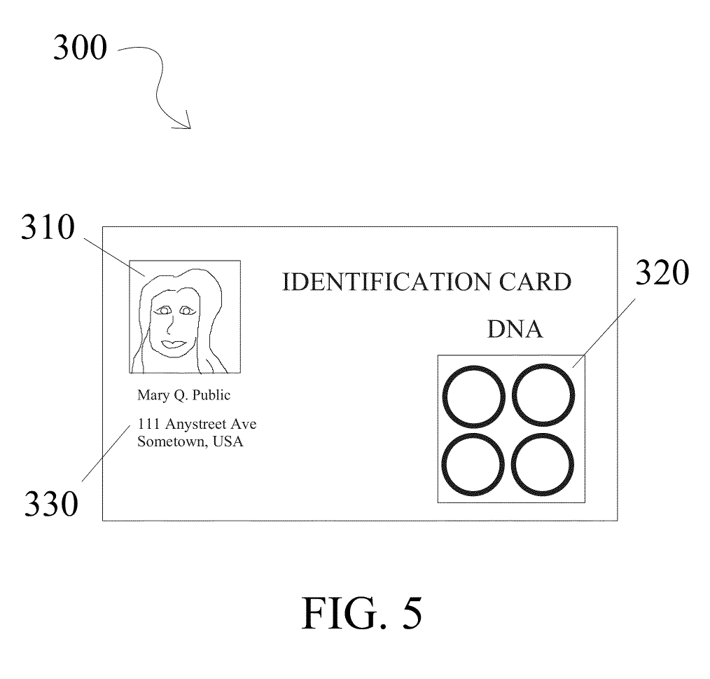

Now referring to FIG. 5, a DNA identification card 300 is shown having printed information 330 such as name and address, etc. In the embodiment shown, a picture 310 is provided to help identify a person. A DNA sample section 320 is provided to store DNA material that can be used to positively identify a person. Again, as discussed above, any suitable DNA storage method may be used to provide stable storage of DNA sample. DNA identification card 300 may be a state driver's license, sheriff's ID, etc.

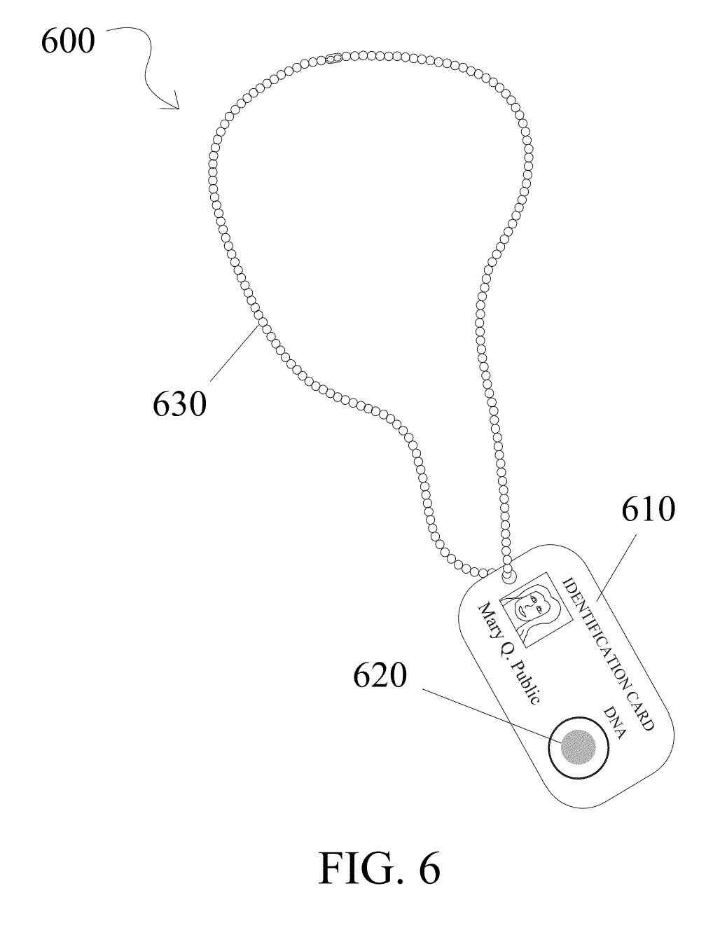

Referring now to FIG. 6, a DNA identification card 600 is shown having a chain or necklace portion 630 with an ID card 610. ID card 610 has a DNA preserving portion 620 as discussed above. Medical information may also be stored on ID card 610.

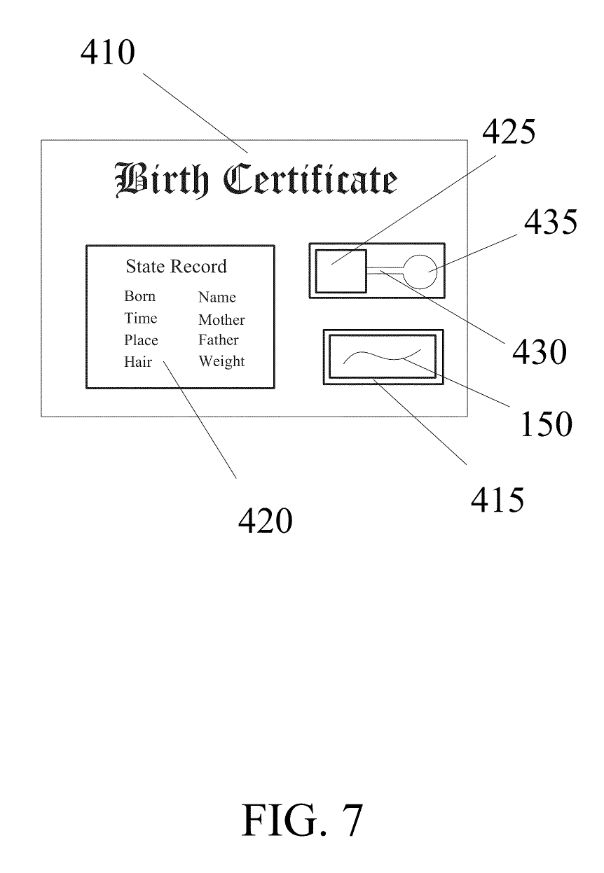

Now referring to FIG. 7, a biometric birth certificate 410 is shown having a printed information area 420 where official seal, birth information, etc. is recorded. In this embodiment, a DNA sequencing chip 425 is mounted on certificate 410 and a blood sample area 435 and blood path 425 is provided to transmit a blood sample to sequencing chip 425. A DNA sample area 415 is provided to store and preserve a biological sample such as hair 150 or other sample. In this embodiment, an almost instant DNA sequence is analyzed and stored in chip 425 for future reference. Chip 425 contains a power source such as a small battery or solar generating panel (not shown) to power chip 425.

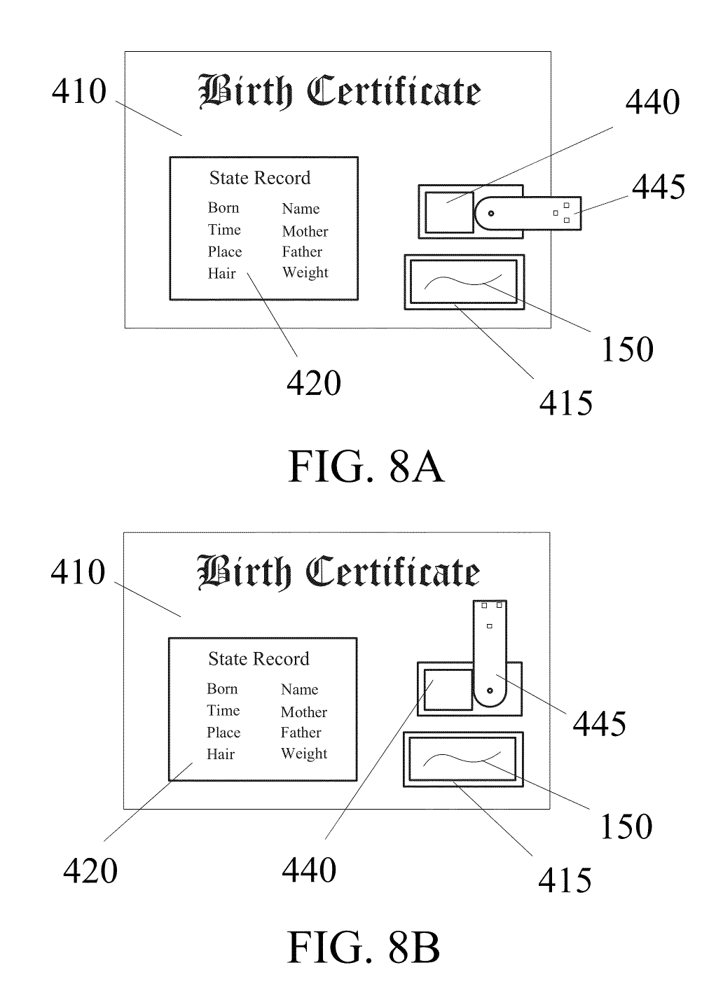

Referring to FIGS. 8A and 8B, the biometric birth certificate 410 is shown having a universal serial bus (USB) 445 connection built in certificate 410. USB connector 445 is connected to non-volatile memory chip 440 to record all the data including DNA results. FIG. 8B shows USB connector rotated to a storage position. Of course, other interface devices may be used, such as, but not limited to mini SD cards, flash sticks, memory cards, etc. In this embodiment, the DNA sample can be processed by a third party and the data uploaded and saved on biometric birth certificate.

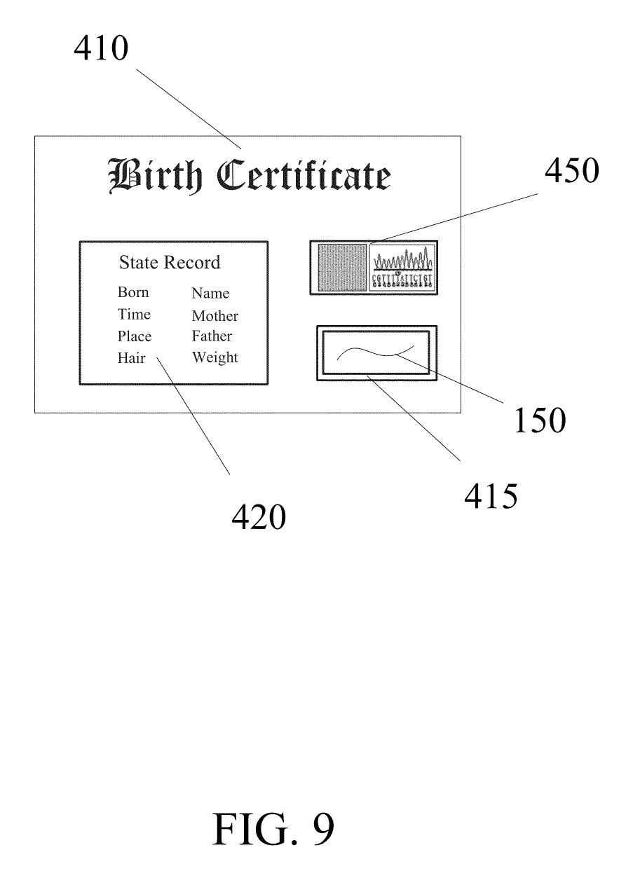

Now referring to FIG. 9, the biometric birth certificate 410 is shown having a DNA computer analysis printout storage section 450. The results may be stored in a compressed format such as a microfilm. In this embodiment, the DNA sample is processed in a laboratory and then the result is permanently stored on biometric birth certificate 410.

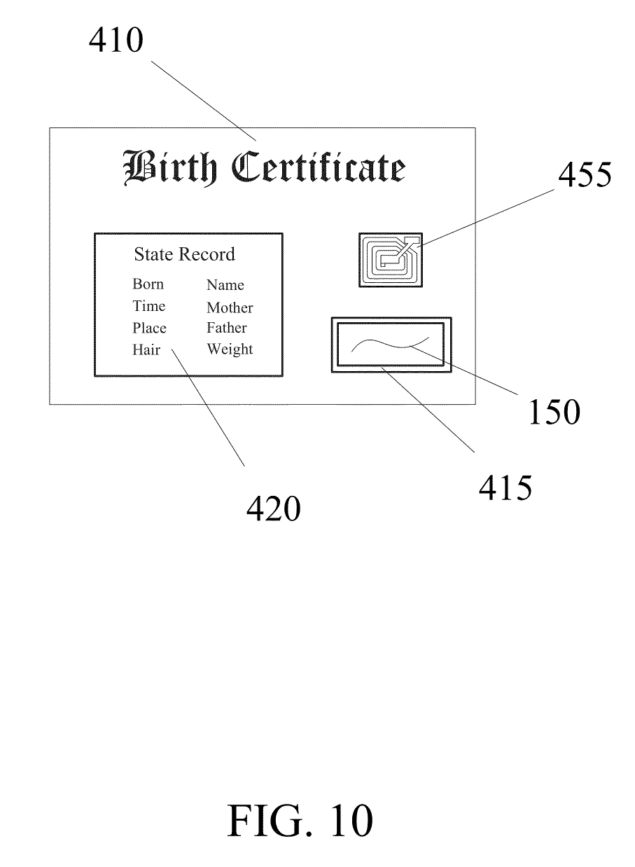

FIG. 10 shows a biometric birth certificate 410 with a radio-frequency identification and detection (RFID) chip 455 attached. Chip 455 stores data including DNA data that has been analyzed and prepared for uploading on to chip. 455. The data can then be stored and read out at a later date by an appropriate RFID reader as is known in the art.

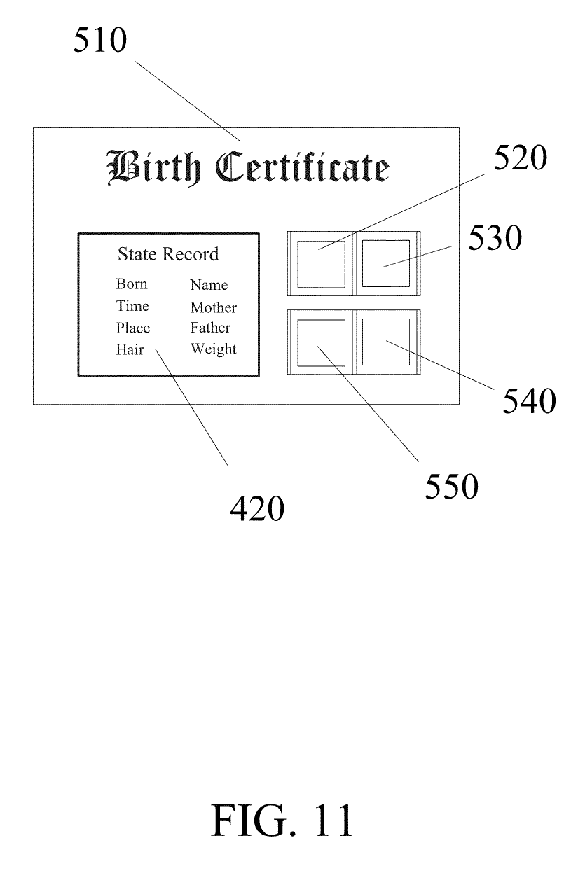

Referring to FIG. 11, a biometric birth certificate 510 is shown having a special area for a DNA sample from the mother 520, father 530, baby 550 and the baby's umbilical cord. This way an entire immediate family history of DNA is included in birth certificate 510 and provides access for any future needs. Sample areas 520, 530, 540 and 550 are sealed to prevent deterioration. They may be hermetically sealed and may be evacuated or filled with an inert gas such as nitrogen to further preserve the samples.

Although the instant invention has been described in relation to particular embodiments thereof, many other variations and modifications and other uses will become apparent to those skilled in the art.

What is claimed is:

1. A biometric birth certificate comprising:
a certificate having a printed data portion wherein birth information is displayed;
a memory device disposed on said certificate;
a means for interfacing an input device with said memory device wherein data is transferred and stored therein; and
a biometric sample storage area wherein a biological sample is stored for future DNA reference.

2. The biometric birth certificate according to claim 1 where said data includes DNA sample results.

3. The biometric birth certificate according to claim 1 wherein said means for interfacing an input device is a USB connector.

4. The biometric birth certificate according to claim 1 wherein said means for interfacing an input device is a memory card.

5. The biometric birth certificate according to claim 1 wherein said input device is a computer.

6. The biometric birth certificate according to claim 1 wherein said memory device is a flash drive.

7. The biometric birth certificate according to claim 1 where said memory device is an RFID chip.

8. The biometric birth certificate according to claim 7 wherein said means for interfacing an input device is an RFID read/write unit.

9. The biometric birth certificate according to claim 7 further comprising a secondary memory device for storing additional data.

10. A biometric birth certificate comprising:
a certificate having a printed data portion wherein birth information is displayed;
a DNA computer printout storage area disposed on said certificate; and
a biometric sample storage area wherein a biological sample is stored for future DNA reference.

11. The biometric birth certificate according to claim 10 wherein said DNA computer printout storage area is a microfilm area.

12. A biometric birth certificate comprising:
a certificate having a printed data portion wherein birth information is displayed;
a first DNA sample compartment disposed on said certificate wherein a DNA sample of first parent is stored;
a second DNA sample compartment disposed on said certificate wherein a DNA sample of a second parent is stored; and
a third DNA sample compartment disposed on said certificate when a DNA sample of the infant is stored.

13. The biometric birth certificate according to claim 12 further comprising a fourth DNA sample compartment disposed on said certificate wherein an additional DNA sample is stored.

14. The biometric birth certificate according to claim 13 wherein said additional DNA sample is said infant's umbilical cord.

15. The biometric birth certificate according to claim 12 wherein said DNA compartments are hermetically sealed.

16. The biometric birth certificate according to claim 15 wherein said DNA compartments are filled with an inert gas before sealing.
